(19) United States
(12) Patent Application Publication
(10) Pub. No.: US 2020/0037616 A1
(43) Pub. Date: Feb. 6, 2020

(54) CONVEYOR OVEN APPARATUS AND METHOD

(71) Applicant: THE MIDDLEBY CORPORATION, Elgin, IL (US)

(72) Inventors: William S. Schjerven, Sr., Schaumburg, IL (US); Richard H. Van Camp, Aurora, IL (US); Theodore James Chmiola, Roscoe, IL (US); Mohan K. Panicker, Darien, IL (US)

(21) Appl. No.: 16/498,191

(22) PCT Filed: Apr. 4, 2018
(86) PCT No.: PCT/US2018/026070

§ 371 Date: Sep. 26, 2019

Related U.S. Application Data
(60) Provisional application No. 62/483,207, filed on Apr. 7, 2017.

(51) Int. Cl. A21B 1/48; A21B 1/26; A21B 3/00

(52) U.S. Cl. CPC A21B 1/48; A21B 3/00; A21B 1/26

(57) ABSTRACT

Conveyor ovens for cooking food product according to various embodiments include a tunnel having an entrance and an exit, a conveyor to move the food product through the tunnel, and a canopy at the entrance and/or at the exit of the tunnel. The canopy can include a top spaced above the conveyor, and a skirt extending downwardly toward the conveyor, wherein the top, skirt, and conveyor define a partially enclosed space through which food product carried by the conveyor passes. Some conveyors ovens have a first configuration in which a cooking chamber of the oven has a first length, and a second configuration in which the cooking chamber is extended to have a longer second length, wherein food product on the conveyor is cooked along the entire first length in the first configuration, and is cooked along the entire second length in the second configuration.

### CROSS-REFERENCE TO RELATED APPLICATIONS

Priority is hereby claimed to U.S. provisional patent application No. 62/483,207 filed on Apr. 7, 2017, the entire contents of which are incorporated herein by reference.

### BACKGROUND

Conveyor ovens are widely used for cooking pizzas and a wide variety of other food products. Examples of such ovens are shown, for example, in U.S. Pat. Nos. 5,277,105, 6,481,433 and 6,655,373, as well as U.S. Pat. Nos. 8,281,779, 8,087,407, and 9,585,401.

Conveyor ovens are typically large metallic housings with a heated tunnel extending through them and a conveyor running through the tunnel. In many cases, such conveyor ovens are either 70 or 55 inches long, although they may be constructed in any other suitable size. The conveyor transports food products through the heated oven tunnel at a speed which cooks food products during their transit through the tunnel. Conveyor ovens typically include a heat delivery system including one or more blowers which supply heat to the tunnel through passageways leading to metal fingers opening into the oven tunnel. Such metal fingers are often located above and below the conveyor. The metal fingers act as airflow channels that deliver streams of hot air which impinge upon the surfaces of the food products passing through the tunnel on the conveyor. In modern conveyor ovens, a microprocessor-driven control panel generally enables the user to regulate heat delivery (e.g., to control the temperature within the oven, the heat output of the heat delivery system, and the like), the speed of the conveyor, and other oven functions to properly cook food product being transported through the oven.

Conveyor ovens are generally controlled with the intent to achieve repeatable and controllable heating of the oven chamber. The conveyor generally travels at a speed calculated to properly cook food products on the conveyor belt during the time period required for the conveyor to carry the food products through the entire length of the oven tunnel. In some conveyor ovens, other food products requiring less time to cook may be placed on the conveyor at a point partially through the oven chamber so that they travel only a portion of the length of the tunnel. A pizza is an example of a food product which might require the full amount of cooking time in order to be completely cooked in the oven. A sandwich is an example of a product which might require only a portion of the full cooking time. In conventional conveyor ovens, the time required to cook a pizza, for example, from an uncooked state to a fully cooked state is in excess of 4 or 5 minutes, regardless of how much heat and air flow are supplied to the conveyor supporting the pizza.

Conveyor ovens are typically used in restaurant kitchens and commercial food manufacturing facilities. Typically, they are kept running for extended periods of time, including periods when food products are not being cooked. Since the inlet and outlet ends of the oven tunnel are open, this means that heat and noise are continuously escaping from the conveyor oven tunnel into the surrounding environment. This escape of heat wastes energy, and also warms the surrounding environment often to unnecessary and uncomfortable levels. This is particularly the case where the conveyor oven is being used in relatively cramped restaurant kitchen environments. The escaping noise is also undesirable, since it may interfere with interpersonal communication among those working near the oven.

A significant problem in operating conventional conveyor ovens relates to the manner in which such ovens are operated by users. In particular, the demands placed upon conveyor ovens to produce cooked food product in as short of a time as possible often tempt users to reduce the amount of time spent the conveyor oven takes in properly cooking the food product. Common and improper manners of such time reduction include the practice of placing food product on the conveyor belt at an advanced location at least partially or fully within the oven, and or removing the food product on the conveyor belt before the food product has moved to the proper location for removal. Both practices can result in undercooked food product, which are typically not only unsatisfactory for the consumer, but can end in the potentially dangerous consumption of undercooked ingredients.

Another problem in conventional conveyor ovens is the lack of versatility of many conveyor oven tunnels, their lengths, and configurations. Typically, conveyor ovens have set tunnel lengths defined at least in part by the relative locations of the conveyor tunnel entrance and exit. The ability to modify the tunnel length and/or to modify the length of the conveyor in areas of the oven that experience cooking temperatures is largely non-existent.

In light of the foregoing, improved conveyor ovens that address one or more of the design and operational challenges described herein, or that otherwise enhance the user's ability to control operation of the conveyor oven, would be welcome additions to the art.

### SUMMARY

Some embodiments of the present invention provide a conveyor oven comprising a tunnel in which food is cooked, a conveyor moveable to convey the food through the tunnel, the tunnel having a length, a set of one or more burners configured to generate heat for the tunnel, and at least one canopy coupled to the tunnel such that a length over which the food is cooked is greater than the length of the tunnel. In some embodiments, the length over which the food is cooked substantially corresponds to the sum of the tunnel length and a length of the at least one canopy.

Some embodiments of the present invention provide a conveyor oven comprising a conveyor, a heated tunnel having a first end and a second end and defining a primary cooking chamber between the first end and the second end and a first canopy coupled to the first end of the tunnel, the first canopy defining a secondary cooking chamber. Some embodiments also include a second canopy coupled to the second end of the heated tunnel, the second canopy defining a tertiary cooking chamber.

In some embodiments, the present application provides a method of increasing the cooking time of food in a conveyor oven. The method includes removing a first eyebrow plate from the conveyor oven and coupling a first canopy to a first opening of a heated tunnel. The method optionally further includes removing a second eyebrow plate from the conveyor oven and coupling a second canopy to a second opening of the heated tunnel. The length of the heated tunnel plus the length of the first canopy and the second canopy define a cooking chamber. The cooking time is defined by the speed of the conveyor and the length of the cooking chamber. The length of the cooking chamber is increased by adding the first and second canopies. Therefore, the cooking time is increased without slowing down the conveyor.

In some embodiments, the present application provides a method of extending a cooking chamber of a conveyor oven. The method includes heating a primary cooking chamber with at least one burner and heating a secondary cooking chamber with heat from the primary cooking chamber. The primary cooking chamber is defined as the chamber surrounded by a housing and the secondary cooking chamber is defined between a canopy and the conveyor. The first canopy is coupled to a first end of the primary cooking chamber. In some embodiments, a second canopy is coupled to a second end of the primary cooking chamber and defines a tertiary cooking chamber between the second canopy and the conveyor. The tertiary cooking chamber is heated with heat from the primary cooking chamber.

Some embodiments of the present invention comprise a movable conveyor upon which food product is cooked; a cooking chamber in which the food product is cooked within the oven; a tunnel through which the conveyor moves, the tunnel having an entrance through which food passes to enter the cooking chamber, and an exit through which food passes to exit the cooking chamber; a canopy releasably secured to the entrance or exit, the canopy having a top extending away from the cooking chamber; and a skirt on at least one side of the canopy and extending downwardly from the top of the canopy; wherein the conveyor and the top and skirt of the canopy define to chamber beneath the canopy though which the food product carried by the conveyor passes.

In some embodiments, a conveyor oven is provided, and comprises a movable conveyor upon which food product is cooked; a housing through which the conveyor moves to transport the food product into and out of the housing, the housing having an entrance through which food on the conveyor passes to enter the housing, and an exit through which food on the conveyor passes to exit the housing; a cooking chamber in which the food product on the conveyor is cooked; wherein the conveyor oven has a first configuration in which the cooking chamber has a first length, and a second configuration in which the cooking chamber is extended to have a second length longer than the first length; and wherein the food product on the conveyor is cooked along the entire first length of the cooking chamber in the first configuration of the oven, and is cooked along the entire length of the cooking chamber in the second configuration of the oven.

In some embodiments, the primary cooking chamber is maintained at a higher temperature than previously possible with the burners because the first and second canopies inhibit heat loss through the openings at the ends of the primary cooking chamber.

In some embodiments, the method includes blocking access to first and second oven openings with respective first and second canopies. Therefore, a user is inhibited from inserting foot directly into the primary cooking chamber and from removing food from the conveyor until the food has exited the primary cooking chamber and the canopies.

The first and second canopies decrease the size of the first and second oven openings. In some embodiments, a distance between the first and second canopies and a conveyor is variable to accommodate different sizes of food. In some embodiments, a length of the canopies as measured along the length of the conveyor is variable.

In some embodiments, a conveyor oven for cooking food product is provided, and includes a tunnel having an entrance and an exit; a conveyor to move the food product through the tunnel; a heating element to heat cooking air to be provided to the tunnel; a heat delivery system to supply the heated cooking air to the tunnel; and a canopy coupled to the oven at one of the entrance and exit of the tunnel, the canopy comprising a top spaced above the conveyor and extending away from the tunnel and a skirt extending downwardly toward the conveyor from one side of the top, wherein the top, the skirt, and the conveyor define a partially enclosed space through which food product carried by the conveyor passes

Some embodiments of the present invention provide a canopy for a conveyor oven for cooking food product, wherein the conveyor oven includes a heated tunnel for cooking food product, the tunnel having an entrance and an exit, and a conveyor to move food product through the tunnel, and wherein the canopy includes a cover configured to be coupled to the conveyor oven adjacent one of the entrance and exit of the tunnel; a top portion extending from the cover, wherein the cover and top portion are configured such that when the cover is coupled to the oven adjacent one of the entrance and exit of the tunnel, the top portion extends away from the tunnel and is spaced above the conveyor; and a skirt extending downwardly toward the conveyor from one side of the top portion, wherein the top portion, the skirt, and the conveyor define a partially enclosed space through which food product carried by the conveyor passes.

In some embodiments, a canopy for a conveyor oven for cooking food product is provided, wherein the conveyor oven includes a heated tunnel for cooking food product, the tunnel having an entrance and an exit, and a conveyor to move food product through the tunnel, and wherein the canopy includes a cover configured to be removably coupled to the conveyor oven adjacent one of the entrance and exit of the tunnel, wherein the cover includes apertures each configured to receive a releasable fastener to removably couple the cover to the oven; a top portion extending from the cover, wherein the cover and the top portion are each configured such that when the cover is coupled to the oven adjacent one of the entrance and exit of the tunnel, the top portion extends away from the tunnel and is spaced above the conveyor; and a first skirt extending downwardly toward the conveyor from a first side of the top portion and a second skirt extending downwardly toward the conveyor from a second opposite side of the top portion, wherein when the canopy is coupled to the oven, the top portion, the first skirt, the second skirt, and the conveyor define a partially enclosed space through which food product carried by the conveyor passes.

Some embodiments of the present invention provide a conveyor oven including a movable conveyor upon which food product is cooked; a housing for cooking the food product and through which the conveyor moves to transport the food product into and out of the housing, the housing having an entrance through which food on the conveyor passes to enter the housing, and an exit through which food on the conveyor passes to exit the housing; a cooking chamber positioned within the housing and in which the food product on the conveyor is cooked; wherein the conveyor oven has a first configuration in which the cooking chamber has a first length, and a second configuration in which the cooking chamber is extended to have a second length longer than the first length; and wherein the food product on the conveyor is cooked along the entire first length of the cooking chamber in the first configuration of the oven, and is cooked along the entire length of the cooking chamber in the second configuration of the oven.

Other aspects of the invention will become apparent by consideration of the detailed description and accompanying drawings.

### BRIEF DESCRIPTION OF THE DRAWINGS

The aspects and features of various exemplary embodiments will be more apparent from the description of those exemplary embodiments taken with reference to the accompanying drawings, in which:

FIG. 1 is a perspective view of a conveyor oven in accordance with an embodiment of the present invention;

FIG. 2 is a front view of the conveyor oven of FIG. 1;

FIG. 3 is a right side view of the conveyor oven of FIG.1;

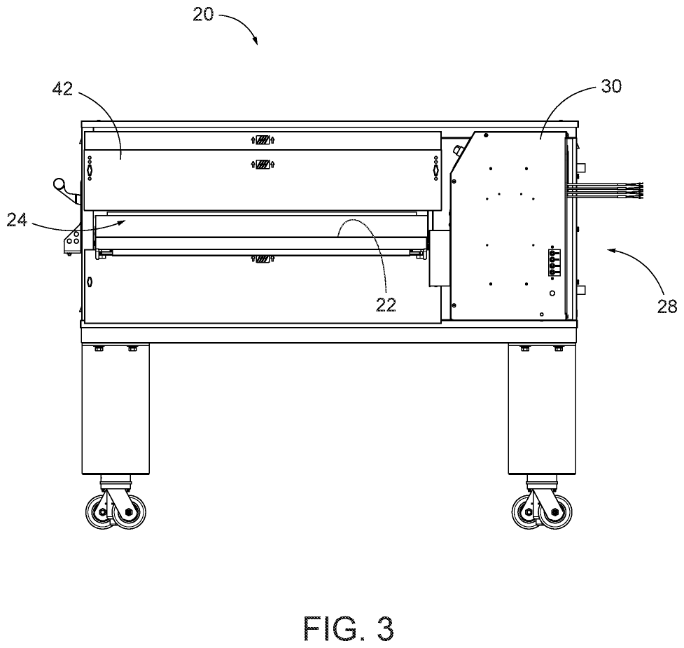

FIG. 4 is a left side view of the conveyor oven of FIG.1;

FIG. 5 is a left side perspective view of the conveyor oven of FIG. 1;

FIG. 6 is a right side perspective view of a first canopy, conveyor oven housing plate, and mounting fasteners, all removed from the conveyor oven;

FIG. 7 is a left side perspective view of a second canopy, conveyor oven housing plate, and mounting fasteners, all shown removed from the conveyor oven;

FIG. 8 is a rear view of the second canopy, conveyor oven housing plate, and mounting fasteners, all shown removed from the conveyor oven and with the second canopy having a first height;

FIG. 9 is a front view of the second canopy, conveyor oven housing plate, and mounting fasteners, all shown removed from the conveyor oven and with the second canopy having a second height;

FIG. 10 is a front view of an embodiment of the second canopy, conveyor oven housing plate, and mounting fasteners, in which the second canopy includes a baffle;

FIG. 11 is an exploded view of the second canopy, conveyor oven housing plate and mounting fasteners, all shown removed from the conveyor oven;

FIG. 12 is a perspective view of the second canopy having an adjustable length;

FIG. 13 is a perspective view of the second canopy having a greater length than the second canopy of FIG. 12;

FIG. 14 is a perspective view of the first canopy removed from the conveyor oven and having an adjustable width;

FIG. 15 is a cross section view of the first canopy along line 15 of FIG. 14.

### DETAILED DESCRIPTION

Before embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

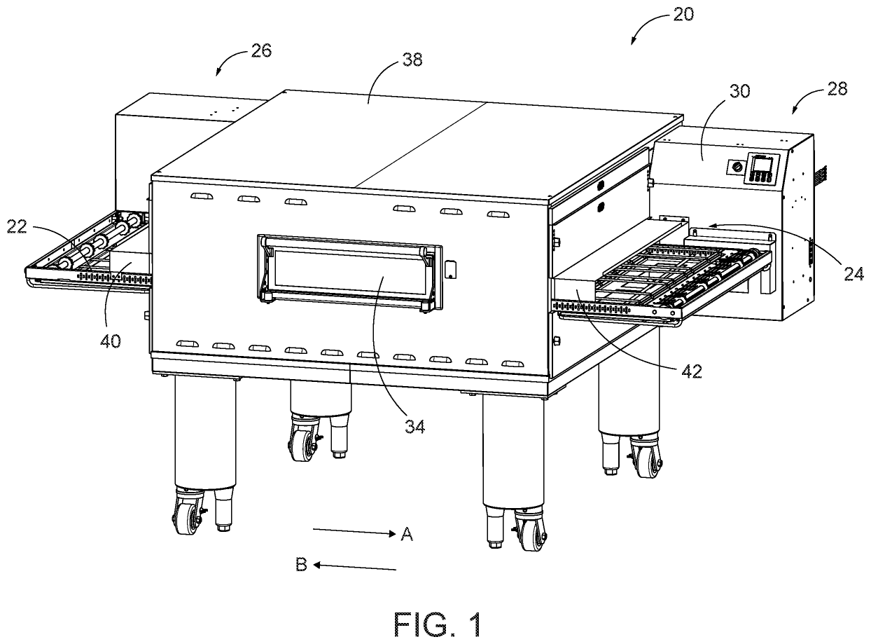

FIG. 1 shows a conveyor oven 20 having a conveyor 22 which runs through a heated tunnel 24 of the oven. The conveyor 22 has a width generally corresponding to the width of the heated tunnel 24, and is designed to travel in direction A from left oven end 26 toward right oven end 28 or, alternatively in direction B, from right oven end 28 toward left oven end 26. Thus, oven ends 26 and 28 may serve respectively as the inlet and outlet of an oven with a rightwardly moving conveyor or as the outlet and inlet of an oven with a leftwardly moving conveyor.

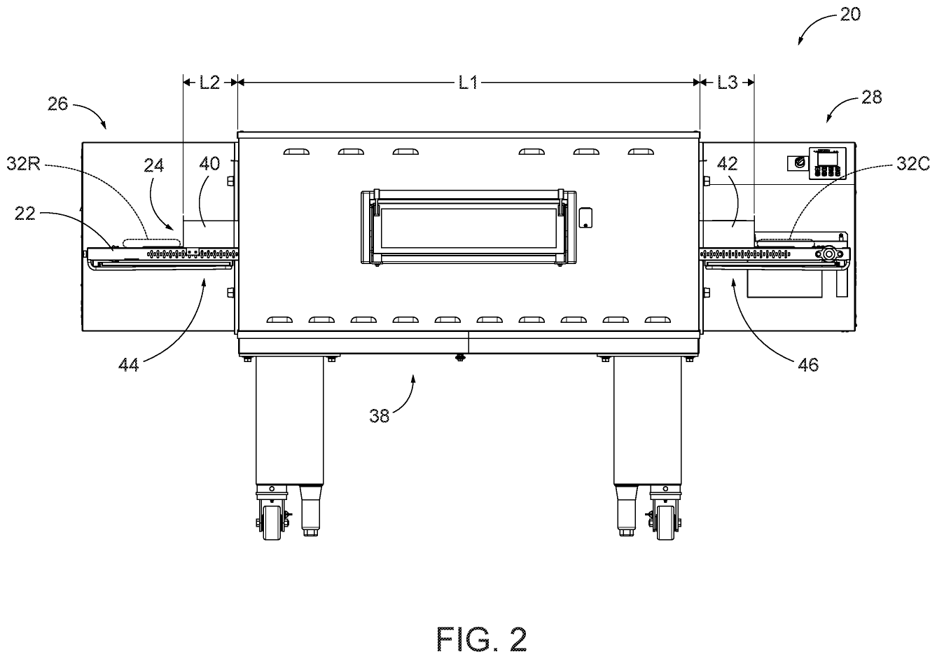

Driving of the conveyor 22 can be achieved through one or more electric motors or other motion control device(s) under the command of a microprocessor-based controller 30, by way of example. The controller 30 may allow a user to adjust parameters of conveyor operation, such as conveyor speed and/or conveyor direction, through a user interface. However, the controller 30 may also control conveyor operation according to predefined algorithms stored and executed by the controller 30 in response to basic inputs from a user, such as predefined settings according to one or more of: food product type, cooking style, cooking time, or target temperature, or in response to simply starting up the oven 20 or the conveyor 22 into an ON state. A food product, such as a raw pizza 32R, may be placed on the conveyor 22 of the ingoing left oven end 26, and removed from the conveyor 22 as fully cooked pizza 32C (see FIG. 2) at the outgoing right oven end 28. The speed at which the conveyor 22 moves is coordinated with the temperature in the heated tunnel 24 so that the emerging fully cooked pizza 32C is completely cooked. In order to minimize cooking time, it is desirable to have the pizza achieve complete cooking just at the time of exit at the exit of the tunnel 24.

In some constructions, the oven 20 includes only a single conveyor 22, provided in one or more sections, that is operable to convey food products at a single speed through the tunnel 24 at any one given time. However, in other constructions, the oven 20 can include two or more separate conveyors. For example, a first conveyor may begin at left oven end 26 and travel at one speed to the center or other location of the oven 20, while a second conveyor beginning at such a location and ending at the right oven end 28 may travel at a different speed. Alternatively, conveyors that are split longitudinally may be used, so that one conveyor carries a product from left oven end 26 to right oven end 28, while the other conveyor carries a product in the opposite direction from right oven end 28 to left oven end 26, or so that two side-by-side conveyors carry product in parallel paths and in the same direction through the tunnel 24. This enables one product to travel on the conveyor at one speed to cook one kind of product and the other conveyor to travel on the other conveyor at a different speed to cook another kind of product. In addition, three or more side-by-side conveyors can carry product in parallel paths through the oven 20.

As shown in FIGS. 1 and 2, a hinged door 34 is provided on the front of the oven 20, so that a person operating the oven 20 can view and/or access the tunnel 24 or food product therein as it travels through the oven 20. The illustrated oven 20 defines a primary cooking chamber 38 in which burners heat any food on the conveyor 22.

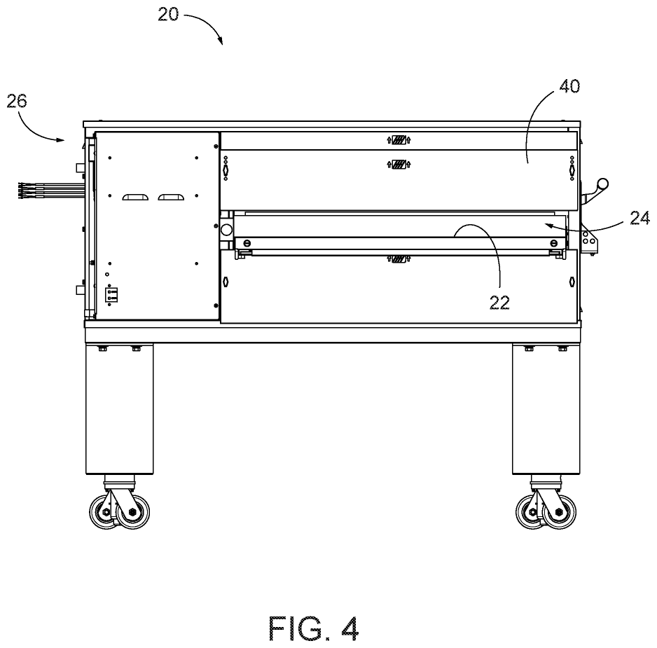

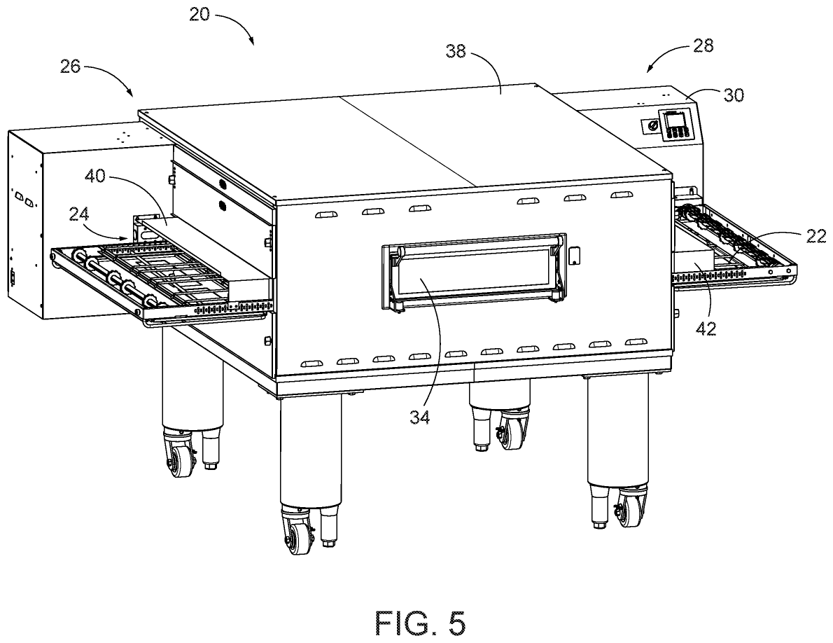

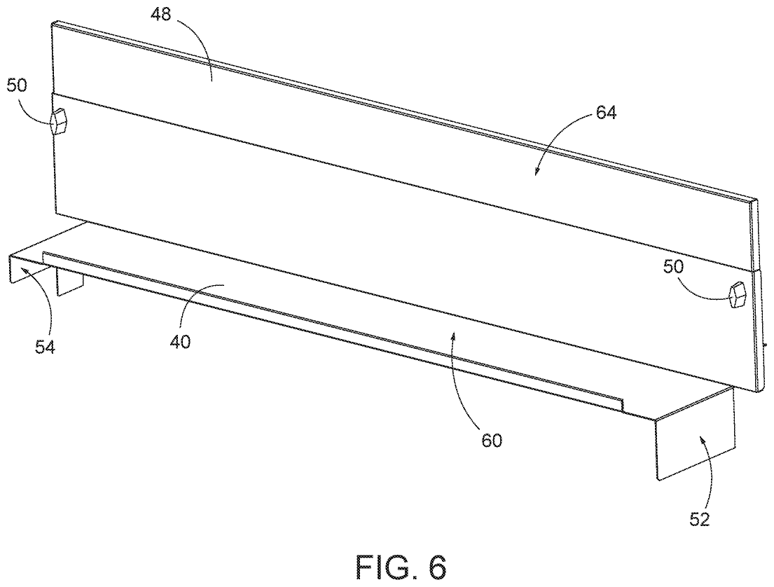

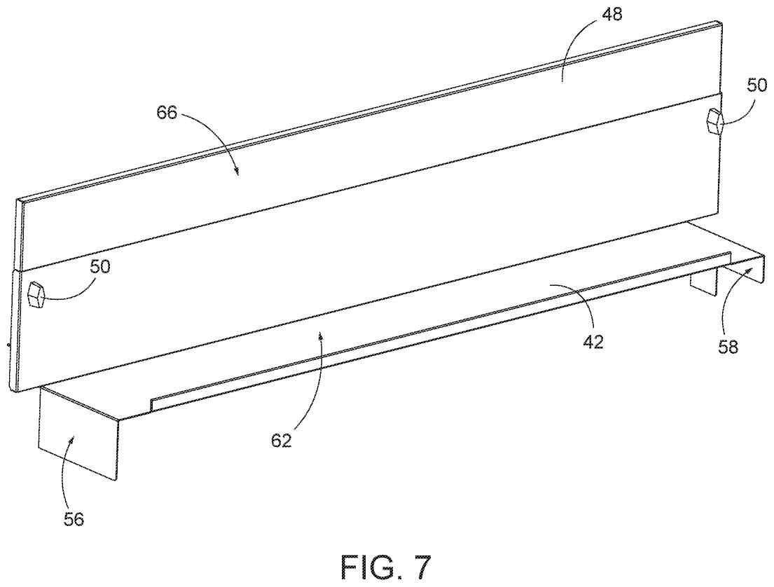

As shown in FIGS. 1, 2, 4 and 5, a first canopy 40 is positioned adjacent a first opening of the heated tunnel 24 at the left oven end 26, and a second canopy 42 is positioned adjacent a second opening of the heated tunnel 24 at the right oven end 28. In other embodiments, the oven 20 is provided with only one of the two canopies 40, 42 (i.e., only the first canopy 40, or only the second canopy 42). In some embodiments, the canopies 40, 42 can be identical, whereas in other embodiments, the canopies can be different, such as mirror images of one another, or differently shaped in order to conform or adapt to adjacent structure of the conveyor oven 20 when installed thereon. By way of example only, the first and second canopies 40, 42 of the illustrated embodiment have different shapes (compare, for example, FIGS. 6 and 7) to enable the canopies 40, 42 to be fitted to the opposite ends of the tunnel 24 while not interfering with adjacent structure of the conveyor oven 20.

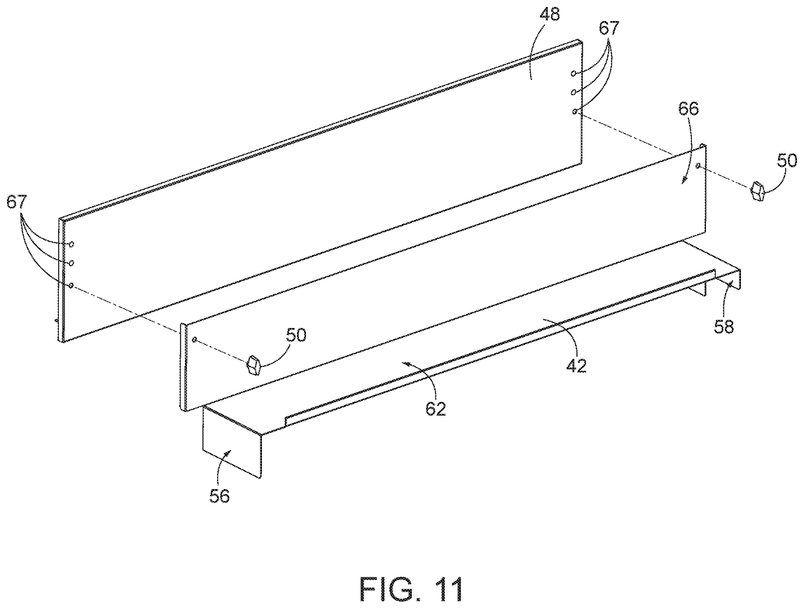

The first canopy 40 is shown in greater detail in FIG. 6. The illustrated first canopy 40 includes a top 60 that extends substantially horizontally along a length of the conveyor 22, a cover 64 extending upward away from the top 60, and a skirt defined by two walls 52, 54 on opposite sides of the first canopy 40. The walls 52, 54 projects downwardly toward the conveyor 22. Similarly, the second canopy 42 includes a top 62 that extends substantially horizontally along a length of the conveyor 22, a cover 66 extending upward away from the top 62, and a skirt defined by two walls 56, 58 on opposite sides of the second canopy 42 as shown in FIGS. 7-11. In some embodiments, the end of the canopy 40, 42 opposite the respective tunnel entrance and exit has a flange that is either inwardly directed (not shown) to reduce the size of the canopy entrance or exit, or is outwardly directed to provide a lip that can be grasped by a user.

Each canopy 40, 42 of the illustrated embodiment is made of an integral sheet of material defining the top 60, 62, the walls 52, 54, 56, 58 of the skirt, and the cover 64, 66, although any or all of these parts of the canopies 40, 42 can be separate elements connected together in any suitable manner, such as by welding, fasteners, inter-engaging elements, brackets, and the like. Also, although the various portions of the canopies 40, 42 illustrated herein are constructed of a single layer of sheet metal, in other embodiments any or all portions of the canopies 40, 42 can include a layer of insulation, or can even be defined by a layer of insulation located between layers of sheet metal.

With continued references to the first and second canopies 40, 42 illustrated in FIGS. 6-9, the top 60, 62 of each canopy 40, 42 extends generally parallel to the conveyor 22 away from the cover 64, 66, and the top 60, 62 of each canopy 40, 42 is generally perpendicular to the cover 64, 66. However, other orientations of the top 60, 62 and cover 64, 66 can instead be used. For example, the top 60, 62 can be oriented at an oblique angle with respect to the conveyor 22 to define a triangular prismatic chamber beneath the top 60, 62 (i.e., between the canopy 40, 42 and the conveyor 22). As another example, the top 60, 62 can present a concave shape to the conveyor 22 to define a curved or rounded chamber beneath the top 60, 62 (i.e., between the canopy 40, 42 and the conveyor 22). Still other shapes and orientations of the canopy top 60, 62 are possible, many of which define respective chambers of different sizes and shapes beneath the top 60, 62 (i.e., between the canopy 40, 42 and the conveyor 22). Like the illustrated canopies 40, 42, either or both ends of these chambers can be at least partially closed by downwardly-depending walls 52, 54, 56, 58. In those embodiments in which the shape of the canopy 40, 42 defines a chamber beneath the top 60, 62 of the canopy 40, 42, the chamber can function to collect and/or retain an amount of heated air received from the oven tunnel 24. The heated air within the canopy 40, 42 can be used to cook food product passing through the canopy 40, 42 (i.e., food product that passes beneath the canopy 40, 42 on the way into or out of the oven tunnel 24). In this manner, the canopy 40, 42 can define a cooking chamber adjacent the entrance or exit of the oven tunnel 24, thereby extending the locations along the conveyor 22 in which food product is cooked. Similar cooking chambers exist beneath the top 60, 62 of canopies 40, 42 that are substantially horizontal as shown in the illustrated embodiment, although with potentially lower volumes of heated air between the canopy 40, 42 and the conveyor 22.

With reference again to FIG. 2, a secondary cooking chamber 44 is defined by the first canopy 40 and the conveyor 22, and a tertiary cooking chamber 46 is defined by the second canopy 42 and the conveyor 22. The primary cooking chamber 38 is heated with at least one heating element (e.g., one or more gas burners, electrical heating elements, and the like), whereas the secondary and tertiary cooking chambers 44 receive heat from the primary cooking chamber 38 through the open entrance and exit of the heated tunnel 24, respectively.

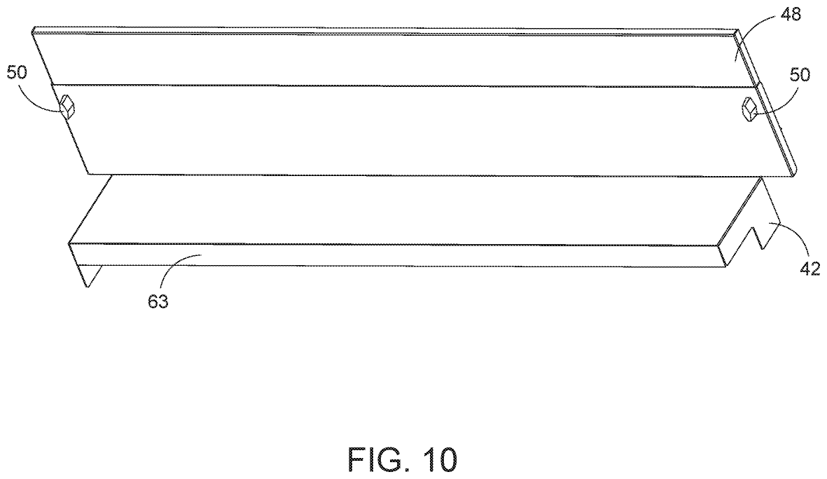

In some embodiments, the underside of the canopy 40, 42 is entirely open without obstructions or other structure, thereby defining a single open chamber beneath the top 60, 62 as described above and illustrated in the accompanying figures. In other embodiments, one or more walls (e.g., baffles 63 shown in FIG. 10) extend downwardly from the top 60, 62 to define two or more compartments beneath the top 60, 62 within which heated air from the oven tunnel 24 can collect. By way of example only, one or more walls extending across the conveyor 22 and downward from the underside of the top 60, 62 can define elongated chambers, each of which extends across the conveyor 22 and beneath which food product passes on its way under the canopy 40, 42. In such cases, the food product can be exposed to air chambers of differing temperatures as the food product passes beneath the canopy 40, 42.

The illustrated skirt is shaped to engage the conveyor oven 10 near the conveyor 22. In some embodiments, such as in the illustrated embodiment, the downwardly-depending walls 52, 54, 56, 58 that define the skirt rest upon or are slightly elevated above the conveyor 22 (or frame thereof) by virtue of the connection between the canopy 40, 42 and the oven 20 (described below). In other embodiments, the skirt is adjustable to enable the skirt to extend and retract in a vertical direction. This vertical adjustability can be enabled in a number of different manners, such as by two or more vertically holes in the walls 52, 54, 56, 58 selectively aligned with at least one hole in a skirt plate and through which at least one fastener can pass to secure the skirt plate in different vertical positions with respect to the wall 52, 54, 56, 58, or vice-versa. As another example, a respective skirt plate (not shown) can wrap at least partially around each wall 52, 54, 56, 58 to enable the skirt plate to slide vertically with respect to each wall 52, 54, 56, 58 while still being connected to the wall 52, 54, 56, 58, in which case the skirt plate can rest upon the conveyor frame when the canopy 40, 42 is installed. As yet another example, each wall 52, 54, 56, 58 can carry a telescoping flat tube that also can rest upon the conveyor frame when the canopy 40, 42 is installed. Still other arrangements between a skirt plate, tube, bracket or other element and each wall 52, 54, 56, 58 are possible. In each such case, the skirt is adjustable such that the length of the skirt can be adjusted as desired in order to partially or fully close the end of the canopy 40, 42 between the top 60, 62 and the conveyor 22 or conveyor frame.

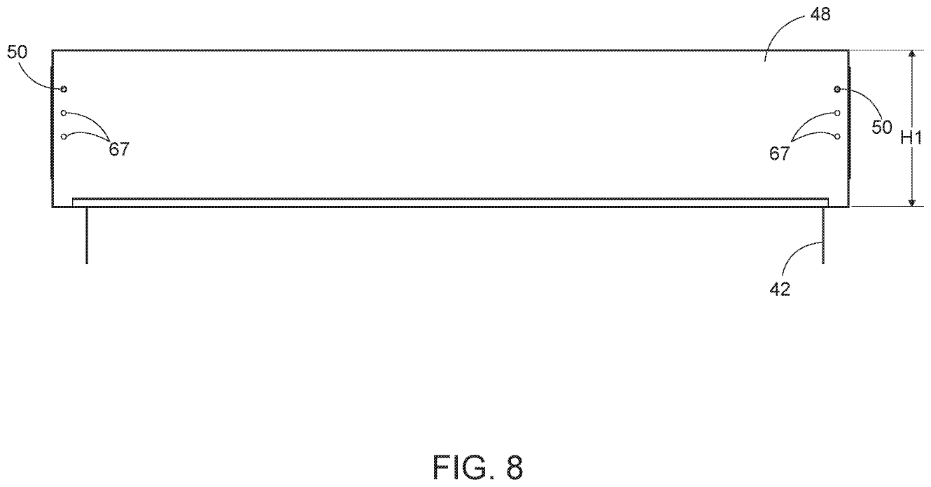

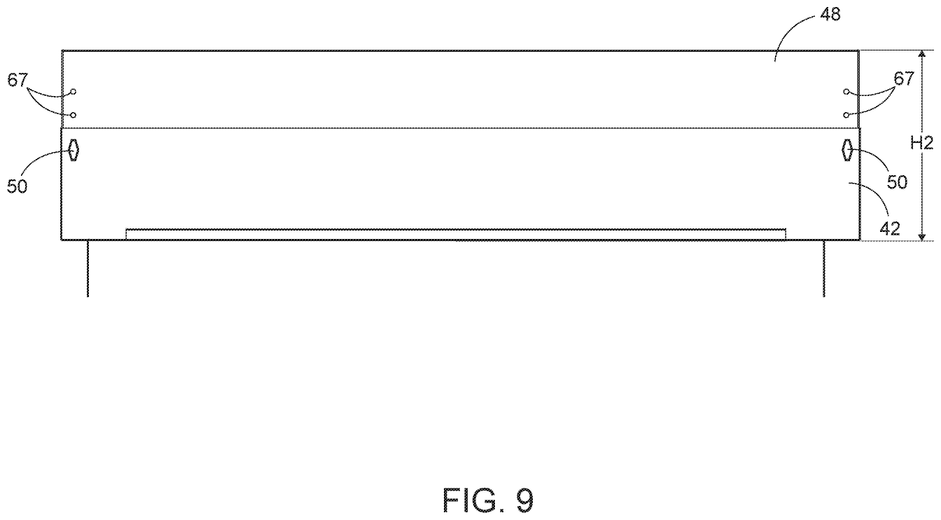

In some embodiments, each canopy 40, 42 is mounted to the oven 20 by being secured to an element of the housing, such as a housing plate 48 on an exterior of the oven 20 as shown in FIGS. 6-11. To mount each canopy 40, 42 to the oven 20 in the illustrated embodiment, releasable fasteners 50 pass through aligned holes in the canopy (e.g., in the cover 64, 66 of the canopy 40, 42, in some embodiments) and the housing plate 48. As illustrated in FIGS. 8 and 9, the housing plate 48 can include a plurality of vertically spaced apertures 67 on opposite sides of the housing plate 48. The apertures 67 are all sized to receive the fasteners 50 to couple the housing plate 48 to the canopy 42 at various heights. For example, the housing plate 48 can be coupled to the canopy 42 at a first height H1 and at a second height H2. In the illustrated embodiment, H2 is greater than H1. The housing plate 48 can also be mounted to the canopy 42 at any of a number of heights and H1 and H2 are shown by way of example only.

In the illustrated embodiment, two such releasable fasteners 50 are used, although any other number of fasteners 50 can be used as desired. In some embodiments, the holes in the housing plate 48 to which the canopy 40, 42 is secured are the same holes as those used to secure an eyebrow plate to the oven 20. An eyebrow plate (not shown) is a plate that is secured with respect to and covers at least a portion of the tunnel entrance or exit, such as a top portion of the tunnel entrance or exit, in order to reduce the vertical size of the tunnel entrance or exit. In some embodiments, the eyebrow plate can be removed and replaced by the canopy 40, 42, which can be secured in place on the oven 20 using the same fasteners used to secure the eyebrow plate. In the illustrated embodiment, the fasteners 50 are threaded twist knobs, wing nuts, or other fasteners that can be tightened and loosened by hand without the need for or use of tools.

Although the canopies 40, 42 can be releasably mounted, and in some cases vertically adjustable with respect to the conveyor 22 as described herein, in other embodiments either or both canopies 40, 42 are permanently secured in place at the tunnel entrance and exit in any suitable manner.

In some embodiments, the height between the canopy 40, 42 and the conveyor 22 is adjustable. For example, the oven (e.g., the housing plate 48 described above) can include multiples threaded apertures 67 to which the first canopy 40 is coupled via threaded fasteners 50 such that the canopy 40, 42 can be secured to the oven 20 at two or more different heights with respect to the conveyor 22. In other embodiments, multiple apertures are instead or also located in the canopy 40, 42 (e.g., in the cover 64, 66 of the canopy 40, 42) for this same purpose. By enabling the use to secure the canopy 40, 42 to the tunnel entrance or exit at two or more different heights using releasable fasteners, the height of the passageway through which food enters and exits the tunnel 24 can be adjusted, such as based upon the type or size of food being cooked. Adjusting the height of the canopy 40, 42 with respect to the conveyor 22 can also define the size of the chamber through which food passes on its way beneath the canopy 40, 42, which can affect the temperature to which the food product is exposed as the food product passes beneath the canopy 40, 42. While three apertures 67 are shown in the illustrated embodiment, other quantities of apertures can be included in other embodiments.

As shown in FIG. 2, the primary cooking chamber 38 of the illustrated conveyor oven 20 has a first length L1, the first canopy 40 has a second length L2, and the second canopy 42 has a third length L3. The illustrated second and third lengths L2 and L3 are substantially identical. However, in other embodiments, the second and third lengths L2 and L3 are different, and can even be adjustable. In other embodiments, the top 60, 62 and/or skirt walls 52, 54, 56, 58 can be adjustable in length in the direction of conveyor travel in other manners, such as by an accordion structure, by hinged panels that can be rotated into and out of place to lengthen or shorten the canopy 40, 42, and the like.

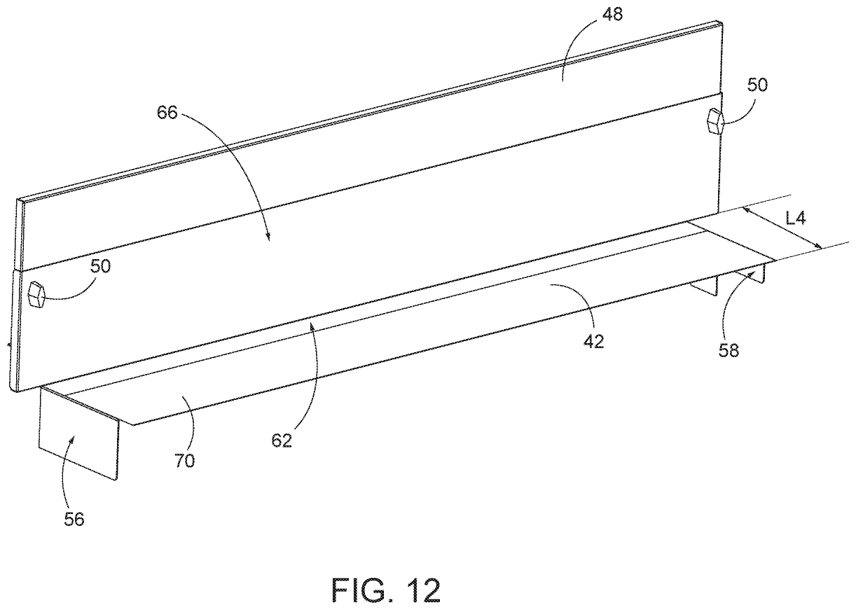

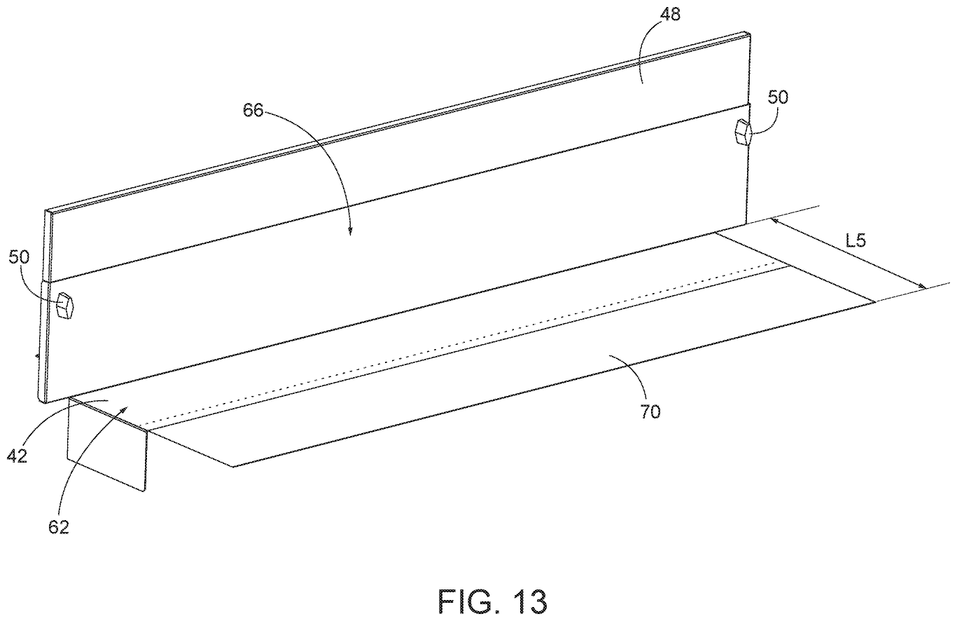

For example, FIGS. 12 and 13 show an adjustable length panel 42 that includes a hinged panel 70 that can be rotated in such that the panel 42 defines a first length L4, and can be rotated out such that panel 42 defines a second length L5, which is greater than L4. In the illustrated embodiment, a portion of the hinged panel 70 overlaps a portion of the top 62 such that the hinged panel 70 abuts a top surface of the top 62 in the stowed position (FIG. 12) and the overlapping portion of the hinged panel 70 abuts a bottom surface of the top 62 in the deployed position (FIG. 13).

In the embodiments in which either or both canopies 40, 42 has a length that is adjustable in the direction of travel of the conveyor 22, such canopies 40, 42 enable a user to thereby adjust the overall chamber size within the canopy 40, 42, and in some cases the length of additional cook time of food product entering or exiting the tunnel 24 (i.e., in addition to the cook time of food product within the oven tunnel 24). Without the first and second canopies 40, 42, the length of the cooking chamber corresponds to the length L1 of the primary cooking chamber 38. However, with the first and second canopies 40, 42 installed, by way of example, the length of the cooking chamber corresponds to the sum of the lengths L1, L2, L3 of the primary, secondary, and tertiary cooking chambers 38, 44, 46. Therefore, because the length of the cooking chamber is increased, in some embodiments the cooking time can be increased without slowing down the conveyor 22.

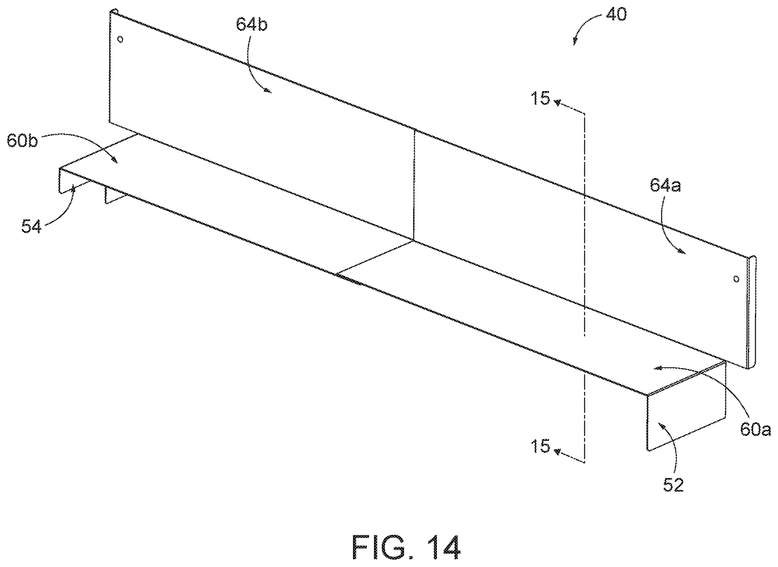

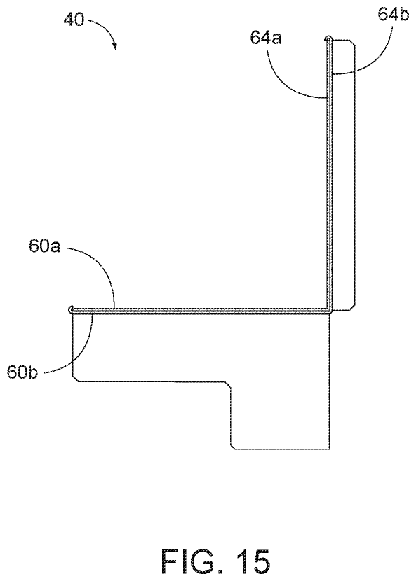

As shown in FIGS. 14 and 15, the canopy 40 can be adjustable in width by, for example, utilizing sliding and telescoping top portions and skirt wall portions, in which case the top of the first canopy 40 includes two separate top portions 60a, 60b movable with respect to one another in the direction of conveyor travel, as well as cover portions 64a, 64b. The second canopy 42 can be similarly adjusted in length, for example, utilizing sliding and telescoping top portions and cover portions in which case the top 62 of the second canopy 42 has two separate portions movable with respect to one another in the direction of conveyor travel, as does the cover 66. Specifically, the configuration shown in FIG. 15 illustrates a cross sectional view showing a connection between the separate portions 60a, 64a, and 60b, 64b.

By using releasable canopies 40, 42 as described and illustrated herein, the conveyor oven 20 is provided with a modular overall tunnel length defined by the conveyor oven tunnel 24 (which is actively heated by one or more heating elements as described herein) and an additional tunnel portion within each installed canopy 40, 42 (which can be passively heated by heated air escaping the entrance or exit of the conveyor oven tunnel). Accordingly, an overall tunnel length is provided that can be adjusted by installing or removing canopies 40, 42 on the oven 20. The canopies 40, 42 therefore provide a modular tunnel structure that provides greater versatility to a conveyor oven 20.

Another feature of the first and second canopies 40, 42 is the interference they provide against users placing food product on the conveyor 22 inside the tunnel 24 or removing food product from the conveyor 22 inside the tunnel 24. By blocking or inhibiting access to the inside of the tunnel 24 through the tunnel entrance and exit, the opportunity for users to attempt to artificially shorten the cook time of food product (which can result in undercooked food) is reduced.

The foregoing detailed description of the certain exemplary embodiments has been provided for the purpose of explaining the principles of the application and examples of practical implementation, thereby enabling others skilled in the art to understand the disclosure for various embodiments and with various modifications as are suited to the particular use contemplated. This description is not necessarily intended to be exhaustive or to limit the application to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

We claim:

1. A conveyor oven for cooking food product, the conveyor oven comprising:
a tunnel having an entrance and an exit;
a conveyor to move the food product through the tunnel;
a heating element to heat cooking air to be provided to the tunnel;
a heat delivery system to supply the heated cooking air to the tunnel; and
a canopy coupled to the oven at one of the entrance and exit of the tunnel, the canopy comprising a top spaced above the conveyor and extending away from the tunnel and a skirt extending downwardly toward the conveyor from at least one side of the top, wherein the top, the skirt, and the conveyor define a partially enclosed space through which food product carried by the conveyor passes.

2. The conveyor oven of claim 1, wherein the canopy is removably coupled to the oven.

3. The conveyor oven of claim 2, further comprising apertures provided in the canopy and an exterior surface of the oven, wherein the apertures are configured to receive releasable fasteners to removably couple the canopy to the oven.

4. The conveyor oven of clam 1, wherein a plurality of vertically-spaced apertures are provided in one of the canopy and an exterior of the oven for coupling the canopy to the oven at different heights above the conveyor.

5. The conveyor oven of claim 1, wherein the canopy and oven are configured such that the canopy can be coupled to the oven at different heights above the conveyor.

6. The conveyor oven of claim 1, wherein the skirt and canopy are configured such that a vertical position of the skirt relative to the conveyor can be adjusted without moving the canopy.

7. The conveyor oven of claim 1, further comprising a skirt plate removably coupled to the skirt, wherein the skirt and skirt plate are configured such that a vertical position of the skirt plate relative to the conveyor can be adjusted without moving the skirt.

8. The conveyor oven of claim 1, wherein the top and skirt of the canopy are formed from one piece of material.

9. A canopy for a conveyor oven for cooking food product, the conveyor oven comprising a heated tunnel for cooking food product, the tunnel having an entrance and an exit, and a conveyor to move food product through the tunnel, the canopy comprising:
a cover configured to be coupled to the conveyor oven adjacent one of the entrance and exit of the tunnel;
a top portion extending from the cover, wherein the cover and top portion are configured such that when the cover is coupled to the oven adjacent one of the entrance and exit of the tunnel, the top portion extends away from the tunnel and is spaced above the conveyor; and
a skirt extending downwardly toward the conveyor from at least one side of the top portion, wherein the top portion, the skirt, and the conveyor define a partially enclosed space through which food product carried by the conveyor passes.

10. The canopy of claim 9, wherein the canopy is formed from one piece of material.

11. The canopy of claim 9, wherein the top portion is flat.

12. The canopy of claim 9, wherein the skirt is a first skirt extending downwardly toward the conveyor from a first side of the top portion and further comprising a second skirt extending downwardly toward the conveyor from a second opposite side of the top portion.

13. The canopy of claim 9, wherein the top portion and the skirt each has a length extending in a direction away from the tunnel when the canopy is coupled to the oven adjacent one of the entrance and exit of the tunnel, and wherein the top portion and the skirt are each configured such that the length of each of the top portion and the skirt is adjustable.

14. The canopy of claim 9, wherein the cover is configured to removably couple the canopy to the oven.

15. The canopy of claim 14, wherein the cover is configured such that the canopy can be removably coupled to the oven at different heights above the conveyor.

16. The conveyor oven of claim 9, further comprising apertures provided in the cover and the oven, wherein the apertures are configured to receive releasable fasteners to removably couple the canopy to the oven.

17. The conveyor oven of clam 9, wherein a plurality of vertically-spaced apertures are provided in one of the cover and the oven for coupling the canopy to the oven at different heights above the conveyor.

18. The conveyor oven of claim 9, wherein the top portion comprises separate portions coupled together and that are movable relative to one another.

19. The conveyor oven of claim 18, wherein the separate portions of the top portion can be moved relative to one another to adjust a length of the top portion.

20. The conveyor oven of claim 18, wherein the separate portions of the top portion can be moved relative to one another to adjust a vertical position of the top portion relative to the conveyor.

21. The conveyor oven of claim 9, wherein the skirt comprises separate portions coupled together and that are movable relative to one another.

22. The conveyor oven of claim 21, wherein the separate portions of the skirt can be moved relative to one another to adjust a length of the skirt.

23. The conveyor oven of claim 21, wherein the separate portions of the skirt can be moved relative to one another to adjust a vertical position of the skirt relative to the conveyor.

24. A canopy for a conveyor oven for cooking food product, the conveyor oven comprising a heated tunnel for cooking food product, the tunnel having an entrance and an exit, and a conveyor to move food product through the tunnel, the canopy comprising:
a cover configured to be removably coupled to the conveyor oven adjacent one of the entrance and exit of the tunnel, wherein the cover includes apertures each configured to receive a releasable fastener to removably couple the cover to the oven;
a top portion extending from the cover, wherein the cover and the top portion are each configured such that when the cover is coupled to the oven adjacent one of the entrance and exit of the tunnel, the top portion extends away from the tunnel and is spaced above the conveyor;
and a first skirt extending downwardly toward the conveyor from a first side of the top portion and a second skirt extending downwardly toward the conveyor from a second opposite side of the top portion, wherein when the canopy is coupled to the oven, the top portion, the first skirt, the second skirt, and the conveyor define a partially enclosed space through which food product carried by the conveyor passes.

25. The canopy of claim 24, wherein the canopy is formed from one piece of material.

26. The canopy of claim 24, wherein the top portion is positioned perpendicular to the cover.

27. The canopy of claim 24, wherein the canopy is configured such that a vertical position relative to the conveyor of one of the top portion and the first and second skirts can be adjusted.

28. A conveyor oven, comprising:
a movable conveyor upon which food product is cooked;
a housing for cooking the food product and through which the conveyor moves to transport the food product into and out of the housing, the housing having an entrance through which food on the conveyor passes to enter the housing, and an exit through which food on the conveyor passes to exit the housing;
a cooking chamber positioned within the housing and in which the food product on the conveyor is cooked;
wherein the conveyor oven has a first configuration in which the cooking chamber has a first length, and a second configuration in which the cooking chamber is extended to have a second length longer than the first length; and
wherein the food product on the conveyor is cooked along the entire first length of the cooking chamber in the first configuration of the oven, and is cooked along the entire length of the cooking chamber in the second configuration of the oven.

29. The conveyor oven of claim 28, wherein in the second configuration of the oven a canopy is coupled to the oven at one of the entrance and exit of the housing to extend the cooking chamber to the second length, wherein the canopy and the conveyor define a partially enclosed space through which food product carried by the conveyor passes.

30. The conveyor oven of claim 29, wherein the canopy is configured such that it can be coupled to the oven at different heights above the conveyor.

31. The conveyor oven of claim 29, wherein the canopy has a length extending in a direction away from the housing when the canopy is coupled to the oven adjacent one of the entrance and exit of the housing, and wherein the canopy is configured such that the length of the top canopy is adjustable.
